(19) United States
(12) Patent Application Publication
(10) Pub. No.: US 2013/0325805 A1
(43) Pub. Date: Dec. 5, 2013

(54) SYSTEM AND METHOD FOR TAGGING AND SECURELY ARCHIVING PATIENT RADIOLOGICAL INFORMATION

(71) Applicant: Dmitriy Tochilnik, San Jose, CA (US)

(72) Inventor: Dmitriy Tochilnik, San Jose, CA (US)

(21) Appl. No.: 13/487,179

(22) Filed: Jun. 2, 2012

(51) Int. Cl. G06F 17/30

(52) U.S. Cl. 707/638; 707/E17.005; 707/E17.014

(57) ABSTRACT

A system and method for tagging and securely archiving patient radiological data includes computing a unique token from at least one of a plurality of data set attribute values, creating a de-identified version of the data set, writing the unique token to the de-identified version of the data set, and transmitting the de-identified version of the data set to an archive for storage. The de-identified version of the data set may be retrieved from the archive by querying and retrieving the de-identified version of the data set having the unique token written thereto.

### CROSS-REFERENCE TO RELATED APPLICATIONS

Not Applicable

### FEDERALLY SPONSORED RESEARCH

Not Applicable

### SEQUENCE LISTING OR PROGRAMMING

Not Applicable

### BACKGROUND OF THE INVENTION

1. Field of the Invention

The preferred embodiments of the present invention generally relate to patient radiological data processing and more particularly to a system and method for tagging and securely archiving patient radiological information.

2. State of the Prior Art

Patient radiological information is conventionally stored as a DICOM (Digital Imaging and Communication in Medicine) data set. A DICOM data set generally includes both an image (such as an x-ray image) and a plurality of attributes (such as the institution name, operator's name, patient's name) associated with the image. Typically, hospitals, clinics and other healthcare facilities maintain DICOM data sets in an on-site database called a Picture Archiving and Communication System (PACS). A PACS allows the healthcare facility to archive the DICOM data sets and provides for sharing and viewing of the data among many users.

Archiving patient radiological information in a PACS is costly as the healthcare facility must pay the PACS vendor each time added functionality is required. In addition, the healthcare facility doesn't own the data and has no control over it. Further, the clinical content generated outlives both the system used to generate it and the media it is stored on. Upgrades to the system and storage media present the healthcare facility with additional costs.

The HIPAA Security Rule establishes standards to protect individuals' electronic personal health information that is created, received, used, or maintained by a covered entity. Appropriate administrative, physical and technical safeguards are required to ensure the confidentiality, integrity and security of protected electronic health information.

Prior art solutions that ensure the confidentiality and security of protected electronic health information include the use of secure communication channels, secure use profiles, secure media via CMS (cryptographic message syntax) envelopes and embedded digital signatures. DICOM attribute or data element encryption (also known as de-identification) may also be employed to secure individuals' personal information. De-identification generally provides for either removing patient identifying information altogether or replacing the information with bogus values.

There is therefore a need for a system and method for archiving patient radiological information that is cost-effective and vendor-neutral. In addition, the archiving system and method must ensure the confidentiality, integrity and security of patient radiological information.

### SUMMARY OF INVENTION

In accordance with a preferred embodiment of the invention, a computer-implemented method for tagging and securely archiving patient radiological information includes the steps of computing a unique token from at least one of a plurality of attribute values of a data set, creating a de-identified version of the data set, writing the unique token to the de-identified version of the data set, and transmitting the de-identified version of the data set to an archive for storage.

In accordance with one aspect of the preferred embodiment, the de-identified version of the data set may be retrieved from the archive by querying and retrieving the de-identified version of the data set having the unique token written thereto.

In accordance with another aspect of the preferred embodiment, the unique token is computed using a hash algorithm.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of the operating system and to the algorithms set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWING FIGURES

The present disclosure may be better understood and its numerous features and advantages made apparent to those skilled in the art by referencing the accompanying drawings wherein:

FIG.1 is a schematic representation of a network environment in which the invention may be practiced;

FIG. 2 is a schematic representation of a healthcare facility hardware device capable of implementing the system and method of the invention;

FIG. 3 is a flow chart of a method of securely archiving patient radiological data;

FIG. 4 is a flow chart of a method of retrieving patient radiological data from an archive;

FIG. 5 is a schematic representation of a database entry storing a token and a selected attribute;

FIG. 6 is a schematic representation of a database entry storing a hash algorithm and a selected attribute;

FIG. 7 is a schematic representation of an archiving data flow between a healthcare facility hardware device and a vendor-neutral archive; and

FIG. 8 is a schematic representation of a query and retrieve data flow between the healthcare facility hardware device and the vendor-neutral archive.

### DETAILED DESCRIPTION OF A PREFERRED EMBODIMENT

The invention will now be described in sufficient detail to enable one skilled in the art to make and use the invention.

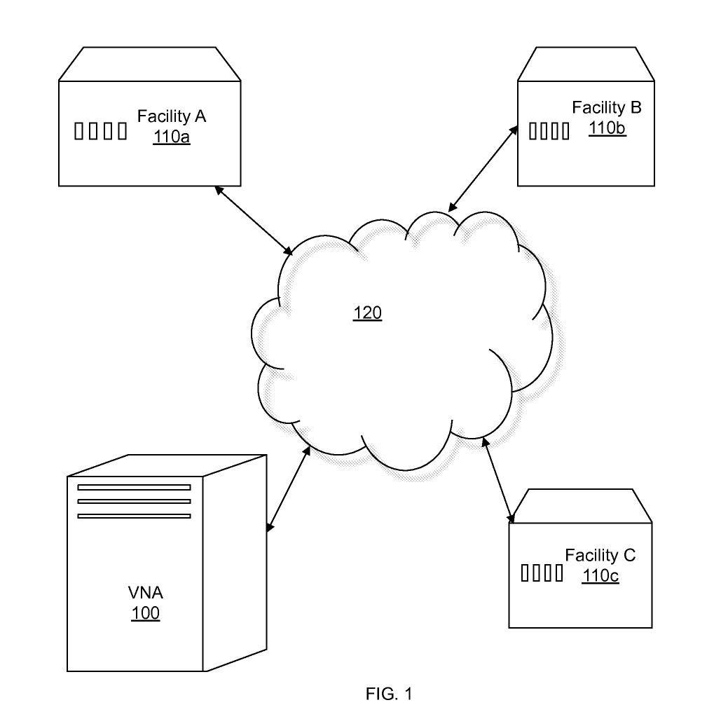

With reference to FIG. 1, the invention generally comprises a software program and computer-implemented method running on any of a plurality of conventional hardware devices 110a, 110b and 110c such as routers or virtual base servers (VMWARE, XEN). The hardware devices 110a, 110b and 110c are communicatively connected to the internet 120 and by this means are communicatively coupled to a vendor neutral archive 100. The hardware devices 110a, 110b and 110c are generally located at the facilities of healthcare providers that generate, and have a need for storage of, patient radiological information while the vendor neutral archive 100 is generally located at a data center.

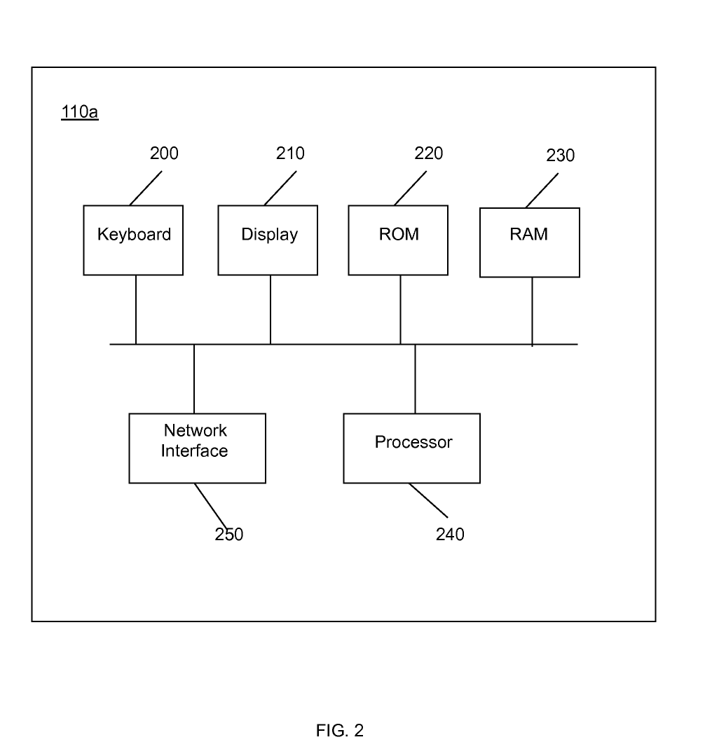

As illustrated in FIG. 2, a representative hardware device 110a includes memory (ROM 220 and RAM 230) for storing computer code implementing the method of the invention. The computer code is capable of being processed by a processor 240. The representative hardware device 110a also includes conventional components such as input/output devices (keyboard 200 and display 210) and a network interface 250 capable of connecting the representative hardware device 110a to the internet 120.

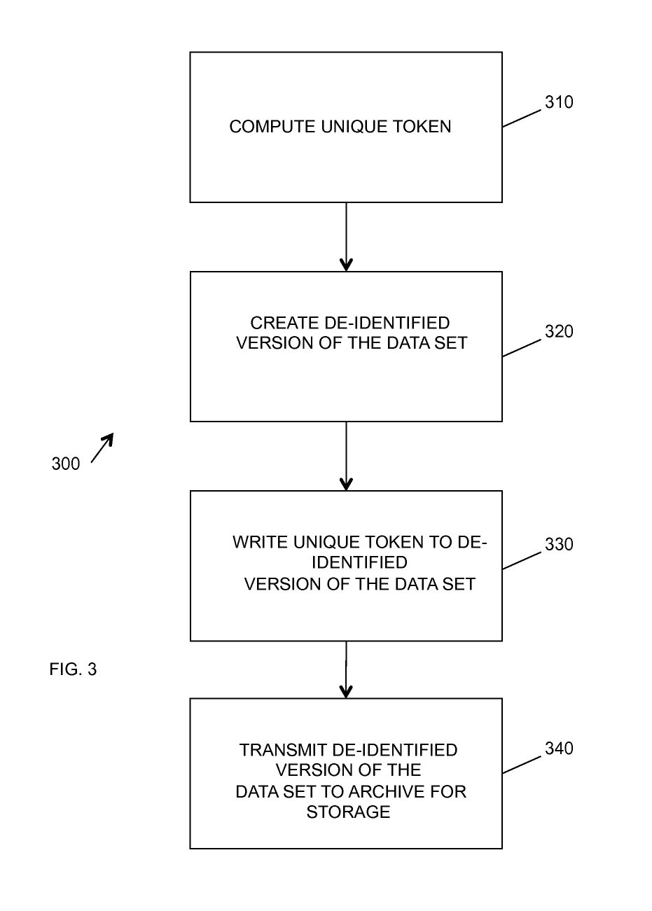

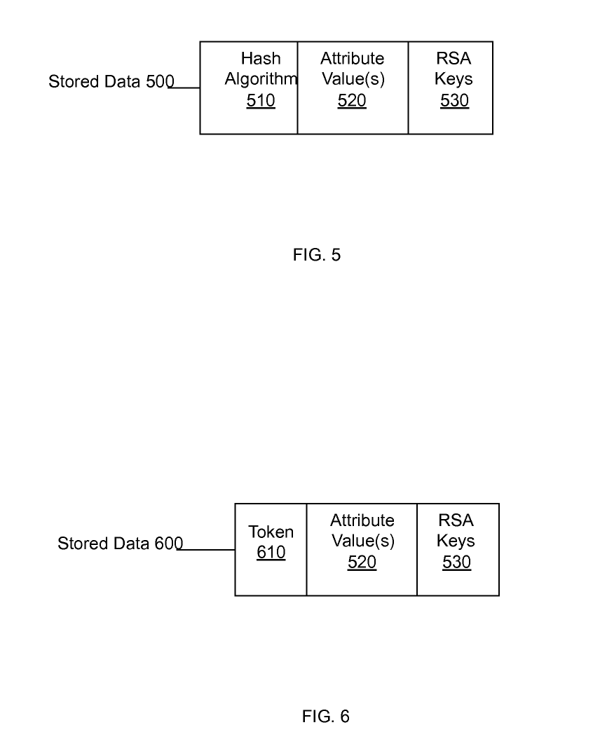

In accordance with a preferred embodiment of the invention, a computer-implemented method 300 (FIG. 3) for tagging and securely archiving patient radiological information includes a step 310 in which a unique token or tag is computed. The unique token is preferably computed from at least one of the plurality of data set attribute values using a hash algorithm. Exemplary values include that of the Patient ID or of the Study Instance UID (SUID). Alternatively, and by example only, the unique token may be computed using any combination of the Patient ID, the Study Instance UID, and the Accession Number values. The hash algorithm 510 (FIG. 5) and the at least one data set attribute value 520 used to compute the unique token are saved as stored data 500 for the purpose of retrieving a de-identified version of the data set from the vendor neutral archive 100 as described below. In an alternative implementation, the unique token 610 (FIG. 6) and the at least one data set attribute value 520 used to compute the unique token are saved as stored data 600 for the same purpose.

The computer-implemented method 300 further includes a step 320 in which the de-identified version of the data set is created. Preferably the de-identified version of the data set is created in accordance with DICOM Part 15: Security and System Management Profiles, Annex E. Annex E provides for application level confidentiality and ensures that all DICOM data attributes that might be used by unauthorized entities to identify the patient are protected.

Protection in this context generally includes the creation of one or more instances of an encrypted attributes data set and copying the attributes to be protected into the single item of the Modified Attributes Sequence (0400,0550) of the encrypted attributes data set instance. Attributes to be protected are listed in Table E.1-1 of Annex E. Each attribute to be protected is then either removed from the data set or its value replaced by a different “replacement value” which does not allow identification of the patient. The encrypted attributes data set instance is then encoded with a DICOM Transfer Syntax, encrypted and stored in the data set to be protected as an item of the Encrypted Attributes Sequence (0400,0500). The encryption is done using RSA [RFC 2313] and RSA keys 530 (FIGS. 5 and 6) saved in the stored data 500 and the stored data 600. Finally, the Patient Identify Removed attribute (0012, 0062) is replaced or added to the data set with a value of YES and a value inserted in De-identification Method (0012,0063) or De-identification Method Code Sequence (0012,0064). Creation 320 of the de-identified version of the data set also includes removing patient identifying information that is burned into the image pixel data and all patient identifying information not listed in Table E.1-1.

The unique token is then written in a step 330 to the de-identified version of the data set (in the Alternative Patient ID attribute for example).

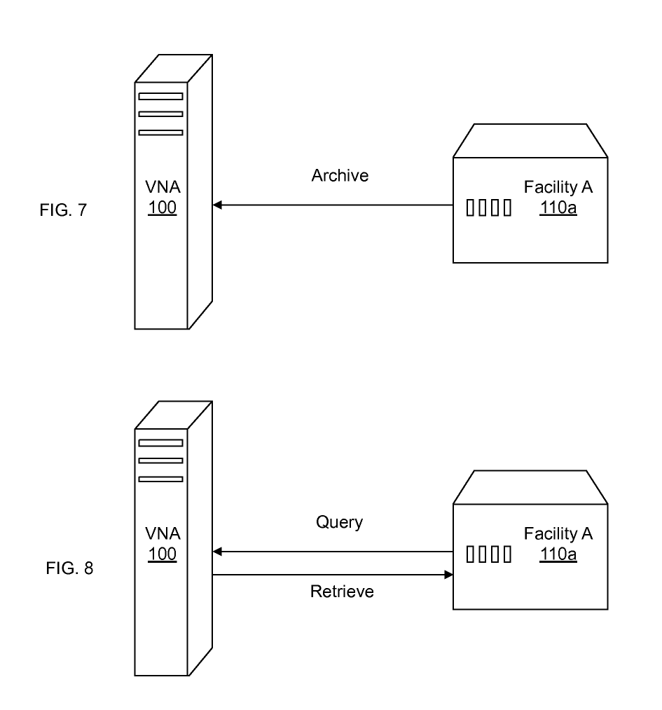

Finally, the de-identified version of the data set is transmitted in a step 340 to the vendor neutral archive 100 for archiving using DICOM over TLS. Step 340 is schematically shown in FIG. 7 in which case a de-identified version of the data set is transmitted from Facility A 110a to the vendor neutral archive 100.

One skilled in the art will recognize that the method 300 of the invention ensures the confidentiality, integrity and security of patient radiological information as required by the HIPAA Security Rule. While the unique token is used to identify the de-identified version of the data set, the unique token has no patient identifying characteristics. Patient identifying information can only be gained from the unique token by those in possession of the hash algorithm used to compute it or of the association between the unique token and the at least one attribute value from which it was computed.

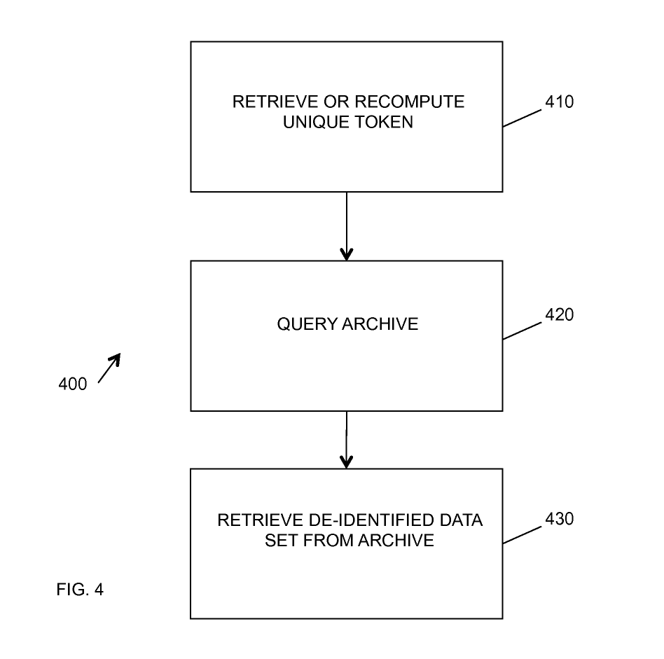

In order to retrieve the de-identified version of the data set from the archive 100, a computer-implemented method 400 (FIG. 4) includes a step 410 in which the unique token is either recomputed using the hash algorithm 510 and the attribute value(s) 520 of the stored data 500 or retrieved from the stored data 600. The vendor neutral archive 100 is then queried in a step 420 using the unique token. The de-identified version of the data set having the unique token written thereto is then retrieved from the vendor neutral archive 100 using DICOM over TLS in a step 430. Steps 420 and 430 are shown schematically in FIG. 8.

In accordance with another embodiment of the invention, a system for tagging and securely archiving radiological information includes hardware (including the processor 240 and associated devices shown in FIG. 2) that is capable of executing the computer code that implements the computer-implemented methods 300 and 400. More specifically, the processor 240 is capable of computing a unique token from at least one of a plurality of data set attribute values, creating a de-identified version of the data set, writing the unique token to the de-identified version of the data set, and transmitting the de-identified version of the data set to an archive for storage. The processor 240 is also capable of retrieving the de-identified version of the data set from the archive by querying and retrieving the de-identified version of the data set having the unique token written thereto.

The system and method for securely archiving patient radiological information in accordance with the invention provides a cost-effective and easy to use means for archiving patient radiological data. Patient information is protected in conformance with the DICOM standard and easily retrievable from the vendor neutral archive by means of a recomputed or retrieved unique token written to the de-identified version of the data set.

I claim:

1. A system for tagging and securely archiving patient radiological information comprising:
a processor, the processor capable of computing a unique token from at least one of a plurality of data set attribute values, creating a de-identified version of the data set, writing the unique token to the de-identified version of the data set, and transmitting the de-identified version of the data set to an archive for storage.

2. The system of claim 1, wherein the unique token is computed using a hash algorithm.

3. The system of claim 2, wherein the processor is further capable of storing the hash algorithm and the at least one of the plurality of data set attribute values used to compute the unique token.

4. The system of claim 1, wherein the processor is further capable of storing the unique token and the at least one of the plurality of data set attribute values from which it was computed.

5. The system of claim 1, wherein the processor is further capable of storing a key for decrypting the de-identified version of the data set.

6. The system of claim 1, wherein the de-identified version of the data set may be retrieved from the archive by querying and retrieving the de-identified version of the data set having the unique token written thereto.

7. The system of claim 1, wherein the at least one of a plurality of data set attribute values comprises a Study Instance UID value.

8. The system of claim 1, wherein the at least one of a plurality of data set attribute values comprises a Patient ID value.

9. The system of claim 1, wherein the at least one of a plurality of data set attribute values comprises a combination of the Patient ID, the Accession Number and the Study Instance UID values

10. A computer-implemented method for tagging and securely archiving patient radiological information comprising the steps of:
computing a unique token from at least one of a plurality of data set attribute values;
creating a de-identified version of the data set;
writing the unique token to the de-identified version of the data set; and
transmitting the de-identified version of the data set to an archive for storage.

11. The computer-implemented method of claim 10, wherein the unique token is computed using a hash algorithm.

12. The computer-implemented method of claim 11, further comprising storing the hash algorithm and the at least one of a plurality of data set attribute values used to compute the unique token.

13. The computer-implemented method of claim 10, further comprising storing the unique token and the at least one of the plurality of data set attribute values from which it was computed.

14. The computer-implemented method of claim 10, further comprising storing a key for decrypting the de-identified version of the data set.

15. The computer-implemented method of claim 10, wherein the de-identified version of the data set may be retrieved from the archive by querying and retrieving the de-identified version of the data set having the unique token written thereto.

16. The computer-implemented method of claim 10, wherein the at least one of a plurality of data set attribute values comprises a Study Instance UID value.

17. The computer-implemented method of claim 10, wherein the at least one of a plurality of data set attribute values comprises a Patient ID value.

18. The computer-implemented method of claim 10, wherein the at least one of a plurality of data set attribute values comprises a combination of the Patient ID, the Accession Number and the Study Instance UID values
